(19) United States
(12) Patent Application Publication
(10) Pub. No.: US 2007/0247662 A1
(43) Pub. Date: Oct. 25, 2007

(54) Processing image data for printing

(75) Inventors: Tsuneo Kasai, Azumino-shi (JP); Fumio Nagasaka, Ueda shi (JP); Iwane Ikeda, Nagano-shi (JP); Takashige Tanaka, Matsamoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/716,432

(22) Filed: Mar. 8, 2007

(30) Foreign Application Priority Data
Mar. 9, 2006 (JP) 2006-063474

(51) Int. Cl. G06K 1/00

(52) U.S. Cl. 358/1.16

(57) ABSTRACT

An image processing apparatus for printing includes an analysis unit, a correction unit, a print-data generating unit, and a storage unit. When first analysis data corresponding to target image data has been generated, the analysis unit does not perform analysis processing on the target image data. When first analysis data corresponding to the target image data has not been generated, the analysis unit performs analysis processing on the target image data and generates second analysis data. The correction unit corrects the target image data using the first or second analysis data corresponding to the target image data and generates corrected image data. The print-data generating unit generates print data using the corrected image data. The storage unit stores the second analysis data in association with the corresponding target image data.

### BACKGROUND

1. Technical Field

The present invention relates to a technique for processing image data for printing.

2. Related Art

Current printers typically have a direct printing feature, i.e., a function of printing without the use of a personal computer. Such a printer generates print data using supplied image data and prints an image on a print medium on the basis of the print data.

With the aim of improving the image quality of a printed image, a current printer analyzes image data, corrects the image data on the basis of the result of the analysis, and generates print data using the corrected image data (see, for example, JP-A-6-169395 and JP-A-2002-344989).

Unfortunately, analyzing image data takes a relatively long time. Therefore, the time required for generation of print data, more specifically, the time between provision of image data and generation of print data is undesirably long.

This problem becomes noticeable as the image quality of a printed image is improved.

This problem arises not only when print data is generated in a printer that has the direct printing feature but also when a personal computer generates print data. In other words, the time required for generation of print data is also long when a personal computer analyzes image data, corrects image data on the basis of the analysis, and generates print data using the corrected image data.

### SUMMARY

An advantage of some aspects of the invention is that it provides a technique capable of reducing the time required for generation of print data.

A first aspect of the invention provides an image processing apparatus for printing including an analysis unit, a correction unit, a print-data generating unit, and a storage unit. When first analysis data corresponding to target image data has been generated, the analysis unit does not perform analysis processing on the target image data. When first analysis data corresponding to the target image data has not been generated, the analysis unit performs analysis processing on the target image data and generates second analysis data. The correction unit corrects the target image data using the first or second analysis data corresponding to the target image data and generates corrected image data. The print-data generating unit generates print data using the corrected image data. The storage unit stores the second analysis data in association with the corresponding target image data.

For this apparatus, when first analysis data corresponding to target image data has been generated, analysis processing does not have to be performed on the target image data; when first analysis data corresponding to the target image data has not been generated, analysis processing is performed on the target image data, and second analysis data is generated. Since the second analysis data is stored in association with the corresponding target image data, in the case in which print data is generated using that print data again, the second analysis data can be used as first analysis data. As a result, the time required for generation of print data can be reduced.

In the apparatus, preferably, the storage unit may store the second analysis data in association with the corresponding target image data into a destination storage medium outside the image processing apparatus.

The storage of second analysis data into a destination storage medium allows the second analysis data to be used afterwards.

In the apparatus, the target image data may be read from a source storage medium outside the image processing apparatus. The destination storage medium may be different from the source storage medium. The storage unit may store the corresponding target image data together with the second analysis data into the destination storage medium.

The storage of both second analysis data and corresponding target image data into a destination storage medium allows the second analysis data to be used afterwards in the same or a different apparatus.

In the apparatus, the storage unit may store the second analysis data in a state of being contained in an analysis file different from an image file that contains the corresponding target image data.

In the apparatus, the second analysis data may be constituted by a plurality of pieces of second analysis data and the target image data may be constituted by a plurality of pieces of target image data, and the analysis file may contain the plurality of pieces of second analysis data corresponding to the plurality of pieces of target image data.

In the apparatus, the storage unit may store the second analysis data in a state of being contained in an image file that contains the corresponding target image data.

Therefore, second analysis data can be easily associated with corresponding target image data.

In the apparatus, the target image data may be read from a source storage medium outside the image processing apparatus. The destination storage medium may be the same as the source storage medium.

The invention can be made in various forms. Examples of the various forms include a printing apparatus, a method for processing image data, a computer program for performing functions of the apparatus or the method, a storage medium that stores the computer program, and a data signal that includes the computer program and that is embodied in a carrier wave.

### BRIEF DESCRIPTION OF THE DRAWINGS

The invention will be described with reference to the accompanying drawings, wherein like numbers reference like elements.

FIG. 1 is a block diagram of a printer according to a first embodiment.

FIG. 2 is a flowchart that shows a procedure of reading processing performed in the printer.

FIG. 3 is a flowchart that shows a procedure of printing processing performed in the printer.

FIG. 4 shows an example of the content of an analysis table obtained in step S128 shown in FIG. 3.

FIG. 5 is a flowchart that shows a procedure of storing processing performed in the printer.

FIG. 6 shows an example of data stored in a destination storage medium.

FIG. 7 shows an example of the content of metadata.

FIG. 8 is a block diagram of a print system according to a second embodiment.

FIG. 9 is a flowchart that shows a procedure of storing processing performed in a personal computer.

### DESCRIPTION OF EXEMPLARY EMBODIMENTS

Embodiments of the invention will now be described with reference to the accompanying drawings in the following order.
A First Embodiment

A-1 Structure of Printer

A-2 Processing in Printer
A-2-1 Reading Processing
A-2-2 Generation of Print Data
A-2-3 Storing Processing

A-3 Use of Analysis Data
A-3-1 First Usage
A-3-2 Second Usage
B Second Embodiment

### A First Embodiment

A-1 Structure of Printer

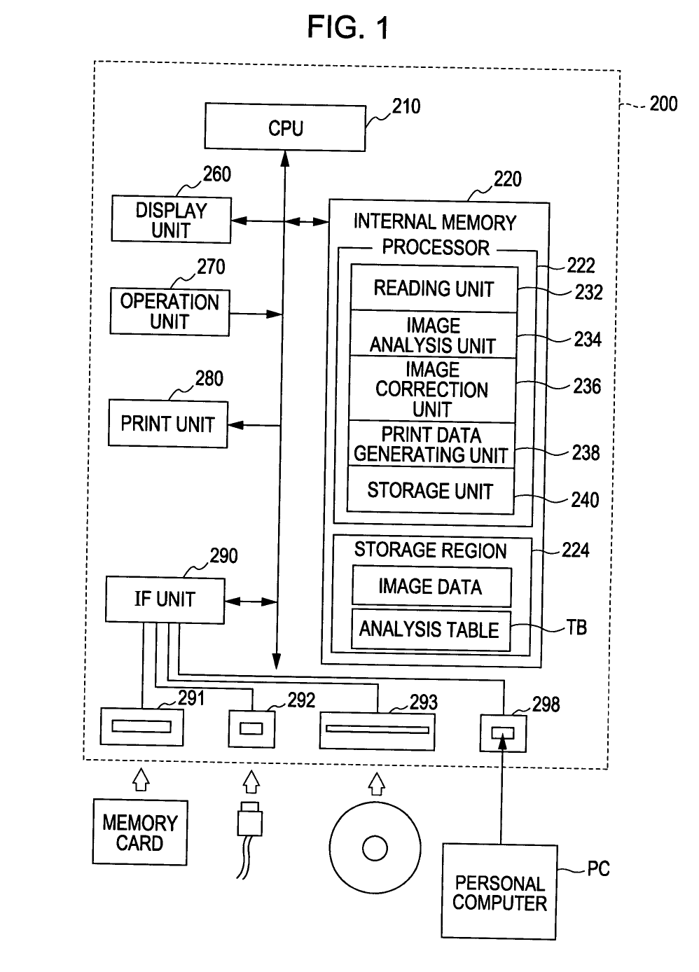

FIG. 1 is a block diagram of a printer 200 according to a first embodiment. The printer 200 includes a central processing unit (CPU) 210, an internal memory 220 (e.g., read-only memory (ROM) and random-access memory (RAM)), a display unit 260, an operation unit 270 (e.g., button), a print unit 280, and an interface (I/F) unit 290.

The I/F unit 290 includes a plurality of interfaces. For example, the I/F unit 290 includes a card slot 291 for accommodating a memory card, such as a flash memory, a USB terminal 292 for connecting to a USB cable, and a CD drive 293 for accommodating a CD-R or other media. The I/F unit 290 also includes a print input terminal 298 for connecting to a personal computer PC to receive print data from the personal computer PC.

Hereinafter, among storage media outside the printer (external storage medium) connected to the printer 200 via the I/F unit 290, an external storage medium used as a source from which information is to be read is sometimes referred to as “source storage medium”, and an external storage medium used as a destination at which information is to be stored is sometimes referred to as “destination storage medium”.

The internal memory 220 (FIG. 1) contains a computer program that functions as a processor 222. The function of the processor 222 is performed by the execution of the computer program by the CPU 210. The computer program is supplied in the form of being stored in a computer-readable storage medium, such as a CD-ROM.

The processor 222 includes a reading unit 232, an image analysis unit 234, an image correction unit 236, a print-data generating unit 238, and a storage unit 240.

The reading unit 232 has a function of reading image data and analysis data from a source storage medium (e.g., memory card) via the I/F unit 290. Specifically, when analysis data is stored in a source storage medium, the reading unit 232 reads both image data and analysis data, whereas, when analysis data is not stored in a source storage medium, the reading unit 232 reads only image data.

As will be described below, in this embodiment, metadata including one or more pieces of analysis data (group of analysis data) corresponding to one or more pieces of image data is read from a source storage medium. Each analysis data is generated by performing analysis processing on corresponding image data, and indicates the result of the analysis for the corresponding image data.

Hereinafter, image data that has been subjected to analysis processing and whose corresponding analysis data is present is sometimes referred to as “first-type image data”, and image data that has not been subjected to analysis processing and whose corresponding analysis data is not present is sometimes referred to as “second-type image data”.

The image analysis unit 234 has a function of performing analysis processing on image data selected as image data to be printed (a print target) and generating analysis data indicating the result of the analysis. Specifically, for first-type image data, the image analysis unit 234 does not perform analysis processing on the image data. For second-type image data, the image analysis unit 234 analyzes the image data and generates analysis data corresponding thereto.

The image correction unit 236 has a function of performing correction processing on image data using analysis data and generating corrected image data. Specifically, for first-type image data, the image correction unit 236 corrects the image data using existing analysis data (first analysis data). For second-type image data, the image correction unit 236 corrects the image data using analysis data (second analysis data) newly generated by the image analysis unit 234.

The print-data generating unit 238 generates print data using corrected image data generated by the image correction unit 236. Specifically, the print-data generating unit 238 first performs color conversion on corrected image data (RGB data) and generates color-converted image data (CMYK data). Then, the print-data generating unit 238 performs halftone processing on the color-converted image data and generates dot data (print data) indicating the formed state of dots.

The storage unit 240 has a function of storing image data and analysis data into a destination storage medium (e.g., CD-R). Specifically, when image data selected as image data to be stored (a storing target) is second-type image data and second analysis data has been generated by the image analysis unit 234, the storage unit 240 stores the image data and the second analysis data into the destination storage medium such that both the image data and the second analysis data are associated with each other. When image data selected as a storing target is second-type image data and second analysis data has not been generated by the image analysis unit 234, the storage unit 240 stores only the image data into the destination storage medium. When image data selected as a storing target is first-type image data, the storage unit 240 stores the image data and first analysis data into the destination storage medium such that the image data and the first analysis data are associated with each other. In this embodiment, the association of image data and analysis data is realized by providing the analysis data with identifying information (e.g., data name) for identifying corresponding image data.

As will be described below, in this embodiment, metadata including one or more pieces of first or second analysis data (group of analysis data) corresponding to one or more pieces of image data is generated, and the generated metadata is stored into the destination storage medium.

The internal memory 220 (FIG. 1) further includes a storage region 224. The storage region 224 contains image data and an analysis table that registers first or second analysis data corresponding to the image data. When the printer 200 has an external storage, such as a hard disk, the storage region 224 may be disposed within the external storage.

In this embodiment, the processor 222 in the printer 200 can receive print data from the personal computer PC via the print input terminal 298. At this time, the processor 222 can cause the print unit 280 to perform printing using the print data.

A-2 Processing in Printer

A-2-1 Reading Processing

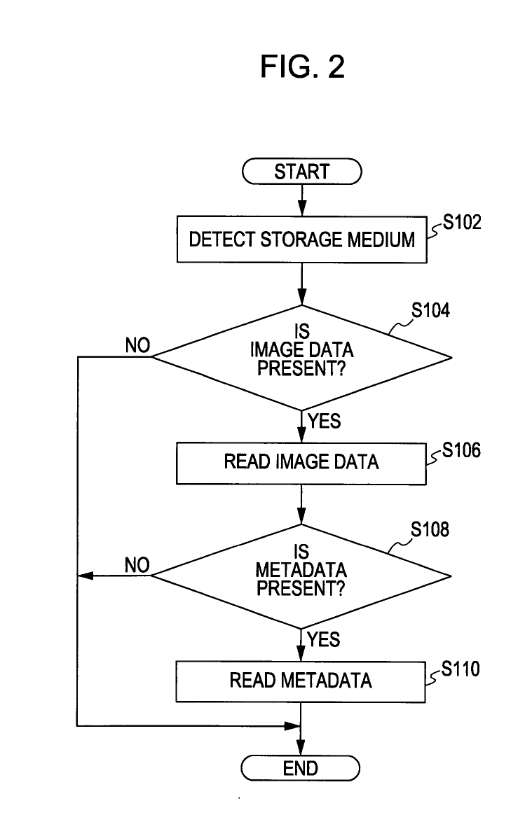

FIG. 2 is a flowchart that shows a procedure of reading processing performed in the printer 200.

In step S102, the processor 222 detects a source storage medium supplied from a user via the I/F unit 290. Here, as the source storage medium, a memory card inserted into the card slot 291 after being detached from a digital camera is assumed.

In step S104, the reading unit 232 determines whether image data is present in the source storage medium. The determination can be performed by, for example, causing the reading unit 232 to refer to directory information in the source storage medium and to check whether the directory information includes a data name that has a specific filename extension (e.g., .jpg). If, in step S104, the image data is not present in the source storage medium, processing shown in FIG. 2 is completed. If, in step S104, the image data is present in the source storage medium, the processing proceeds to step S106.

In step S106, the reading unit 232 reads a plurality of image data from the source storage medium and stores the plurality of image data into the storage region 224.

In step S108, the reading unit 232 determines whether metadata (group of analysis data) is present in the source storage medium. The determination can be performed by, for example, causing the reading unit 232 to refer to directory information in the source storage medium and to check whether the directory information includes a data name that has a specific filename extension (e.g., .mf). If, in step S108, the image data is not present in the source storage medium, processing shown in FIG. 2 is completed. If, in step S108, the image data is present in the source storage medium, the processing proceeds to step S110.

In step S110, the reading unit 232 reads the metadata (group of analysis data) from the source storage medium. At this time, the image analysis unit 234 registers a plurality of first analysis data contained in the metadata corresponding to the plurality of image data into an analysis table TB within the storage region 224.

Here, it is assumed that a plurality of image data is present in the source storage medium and metadata (group of analysis data) is not present therein. That is, it is assumed that a plurality of second-type image data is present in the source storage medium. In this case, processing of step S110 is not performed. A case in which processing of step S110 is performed will be described below.

A-2-2 Generation of Print Data

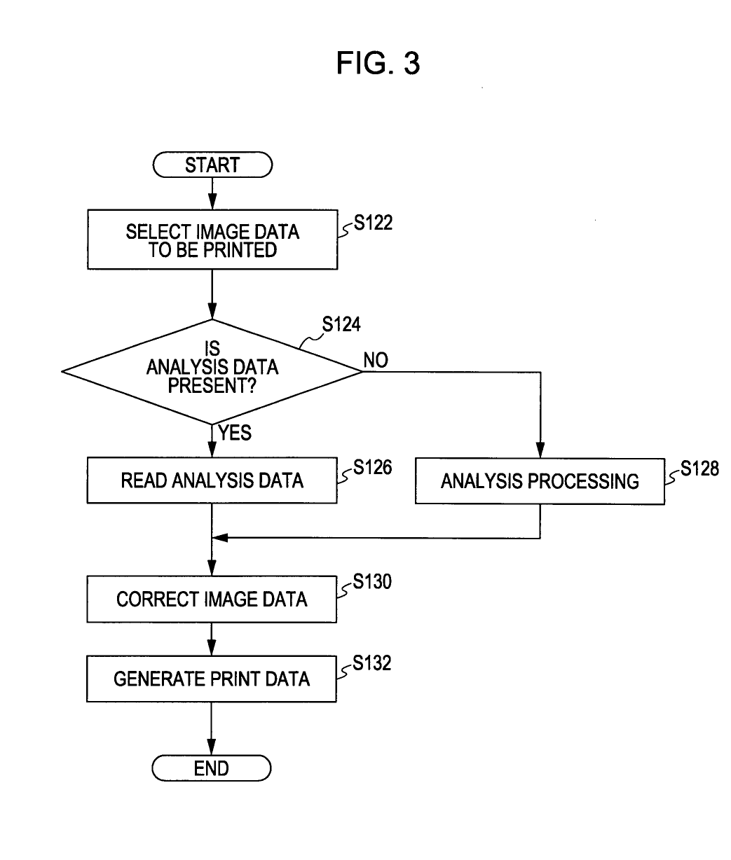

FIG. 3 is a flowchart that shows a procedure of print-data generating processing performed in the printer 200.

In step S122, the processor 222 causes a user to select print-target image data. Specifically, the processor 222 causes the display unit 260 to display a list of a plurality of image data stored in the storage region 224 in response to an instruction from the user. The display unit 260 displays a plurality of thumbnail images corresponding to the plurality of image data. The user views data on the display unit 260 and selects print-target image data. At this time, the processor 222 reads from the storage region 224 the selected print-target image data.

In step S124, the processor 222 determines whether the analysis table TB has analysis data corresponding to the print-target image data. The determination can be performed by, for example, checking whether the analysis table TB has the name of the print-target image data. If, in step S124, the analysis table TB has the analysis data, i.e., if the print-target image data is first-type image data, the processing proceeds to step S126. If, in step S124, the analysis table TB does not have the analysis data, i.e., if the print-target image data is second-type image data, the processing proceeds to step S128.

In step S126, the processor 222 reads from the analysis table TB analysis data (first analysis data) corresponding to the print-target image data (first-type image data).

In step S128, the image analysis unit 234 analyzes the print-target image data (second-type image data). Then, the image analysis unit 234 registers analysis data (second analysis data) into the analysis table TB.

In step S130, the image correction unit 236 corrects the print-target image data and generates corrected image data. Specifically, when the print-target image data is first-type image data, the image correction unit 236 corrects the image data using the analysis data read in step S126 (first analysis data). When the print-target image data is second-type image data, the image correction unit 236 corrects the image data using the analysis data generated in step S128 (second analysis data).

In step S132, the print-data generating unit 238 generates print data using the corrected image data generated in step S130. Then, the processor 222 supplies the print data to the print unit 280, and the print unit 280 prints information on the basis of the print data.

If, in step S122, a plurality of image data is selected as a print target, the plurality of image data is subjected to processing of steps S124 to S132.

As described above, since it is assumed that processing of step S110 shown in FIG. 2 is not performed here, processing of step S126 is not performed. A case in which the processing of step S126 is performed will be described below.

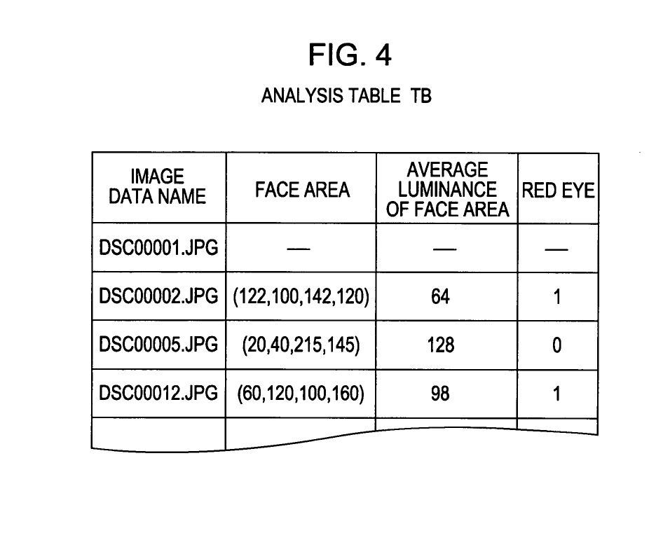

FIG. 4 shows an example of the content of the analysis table TB obtained in step S128 shown in FIG. 3. As shown in FIG. 4, the analysis table TB has information about “image data name”, information about “face area”, information about “average luminance of face area”, and information about “red eye”. The “image data name” information indicates the data name of image data. The “face area” information indicates the face area of a person who is present in an image represented by the image data. More specifically, the “face area” information indicates the coordinates of a starting point and those of an end point of a rectangular region that surrounds the face area of the person. The “average luminance of face area” information indicates the average luminance (Y) calculated using pixel values of a plurality of pixels constituting the face area of the person. The “red eye” information indicates the presence/absence of the red-eye effect, in which an eye of the person appears red.

As is evident from FIG. 4, an image represented by image data of “DSC00001.JPG” does not show people, and analysis data corresponding to the image data does not include significant information. In contrast, an image represented by image data of “DSC00002.JPG” shows a person, and analysis data corresponding to the image data includes significant information.

As is apparent from the foregoing, in this embodiment, in step S128, the image analysis unit 234 performs, on image data, analysis processing for obtaining analysis data that includes the “face area” information, the “average luminance of face area” information, and the “red eye” information. Then, the image analysis unit 234 associates the image data and the obtained analysis data by registering the data name of the image data and the obtained analysis data into the analysis table TB.

In this embodiment, in step S130, the image correction unit 236 corrects each image data using analysis data that is registered in the analysis table TB and that corresponds to the image data. For example, if the value of the “average luminance of face area” information is smaller than a predetermined value, the image correction unit 236 increases the pixel value of each of pixels constituting a face area (skin-tone area) within a rectangular region defined by the “face area” information. If the value of the “red eye” information is a value that indicates the presence of the red-eye effect (i.e., 1), the image correction unit 236 changes the pixel value of each of pixels constituting an eye area (red-eye area) within a rectangular region defined by the “red eye” information.

In this embodiment, analysis processing and correction processing relating to the brightness of a face and the red-eye effect are performed. However, in place of or in addition to such processing, analysis processing and correction processing relating to, for example, the vibrancy of green of plants, blue of the sky and the sea, softness, and sharpness may be performed.

As described above, when print-target image data is first-type image data, the image analysis unit 234 does not have to perform analysis processing. When print-target image data is second-type image data, the image analysis unit 234 can perform analysis processing. That is, since analysis processing can be omitted when print-target image data is first-type image data, the time required for analysis processing can be reduced, compared with a case in which analysis processing is performed on print-target image data at every time. As a result, the time required for generation of print data can be reduced, while at the same time an image can be printed with improved image quality by the use of analysis data.

A-2-3 Storing Processing

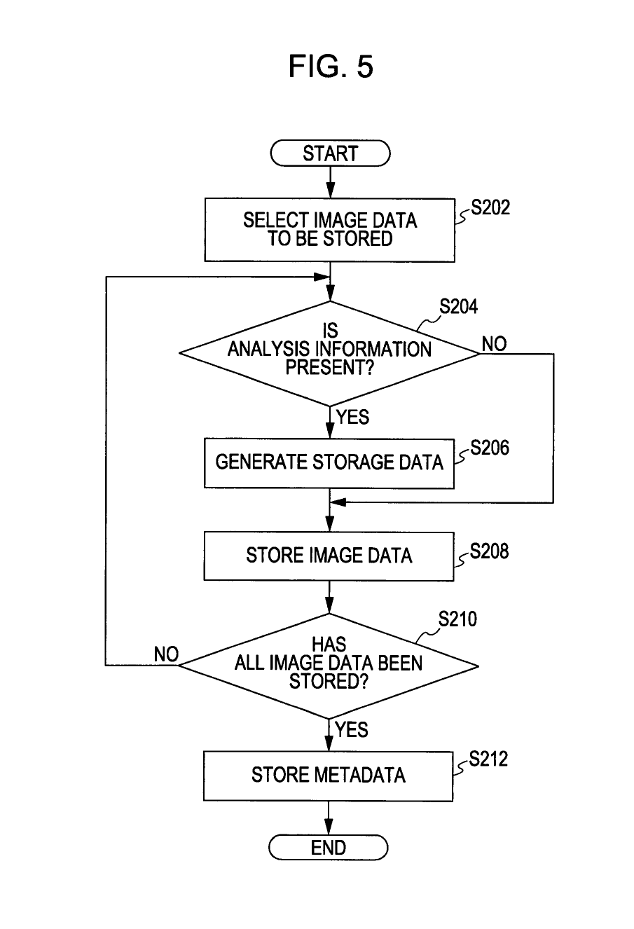

FIG. 5 is a flowchart that shows a procedure of storing processing performed in the printer 200.

In step S202, the processor 222 causes a user to select storing-target image data. Specifically, the processor 222 causes the display unit 260 to display a list of a plurality of image data stored in the storage region 224 in response to an instruction from the user, as in step S122 (FIG. 3). The user views data on the display unit 260 and selects storing-target image data. At this time, the processor 222 reads from the storage region 224 the selected storing-target image data.

In step S202, the user provides the I/F unit 290 with a destination storage medium and designates the destination storage medium as a storage destination. In this embodiment, as the destination storage medium, a CD-R inserted in the CD drive 293 is assumed.

In step S204, the storage unit 240 determines whether the analysis table TB has analysis data corresponding to the storing-target image data. The determination can be performed by, for example, checking whether the analysis table TB has the name of the storing-target image data. For a first case, in which the analysis table TB has the analysis data, the processing proceeds to step S206. The first case includes a case in which the storing-target image data is first-type image data and another case in which the storing-target image data is second-type image data, the image data is selected as a print target, and analysis data corresponding to the image data is generated in step S128. For a second case, in which the analysis table TB does not have analysis data, the processing proceeds to step S208. The second case includes a case in which the storing-target image data is second-type image data, the image data is not selected as a print target, and analysis data corresponding to the image data is not generated in step S128.

In step S206, the storage unit 240 generates storage data (analysis data) corresponding to the storing-target image data using the first or second analysis data that is registered in the analysis table TB and that corresponds to the storing-target image data. The storage data will be described below.

In step S208, the storage unit 240 stores the storing-target image data into the destination storage medium via the I/F unit 290.

In step S210, the storage unit 240 determines whether storing of all image data selected in step S202 is completed. If storing of all selected image data is not completed, the processing returns to step S204, and processing of steps S204 to S210 is repeated. If storing of all selected image data is completed, the processing proceeds to step S212.

In step S212, the storage unit 240 generates a single piece of metadata including one or more pieces of storage data (analysis data) that are generated in step S206 and that correspond to one or more pieces of storing-target image data. Then, the storage unit 240 stores the metadata into the destination storage medium.

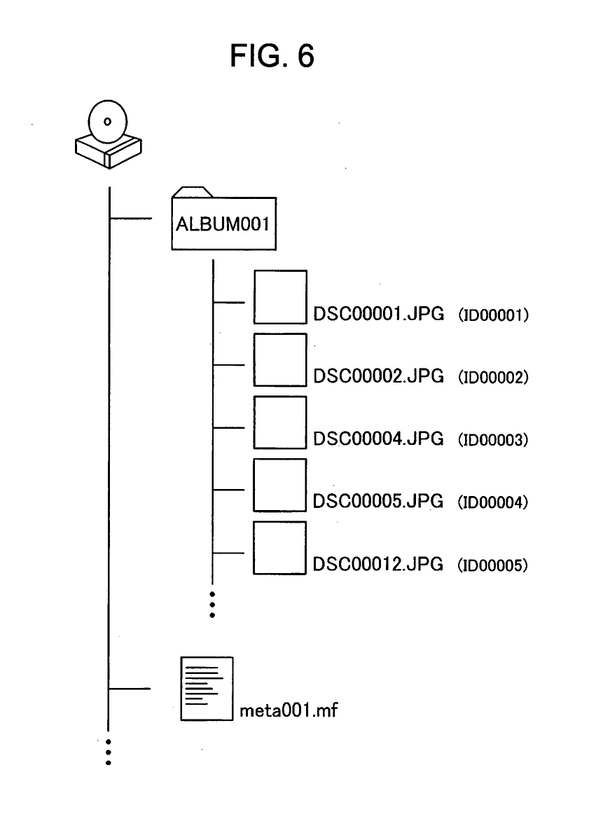

FIG. 6 shows an example of data stored in a destination storage medium. As shown in FIG. 6, the destination storage medium contains a folder (i.e., album) of “ALBUM001” including a plurality of image data (DSC00001.JPG, DSC00002JPG, DSC00004.JPG, DSC00005.JPG, DSC00012.JPG, . . . ) and metadata of “meta001.mf” including a plurality of storage data (analysis data). In this embodiment, the name of a folder or the name of metadata are assigned by the storage unit 240. However, they may be set by a user.

As is evident from comparison of FIGS. 4 and 6, in this embodiment, all of image data selected as a print target and subjected to analysis processing (DSC00001.JPG, DSC00002JPG, DSC00005.JPG, DSC00012.JPG, . . . ) is selected as storing-target image data, and image data that has not been selected as a print target and not been subjected to analysis processing (DSC00004.JPG) is also selected as storing-target image data.

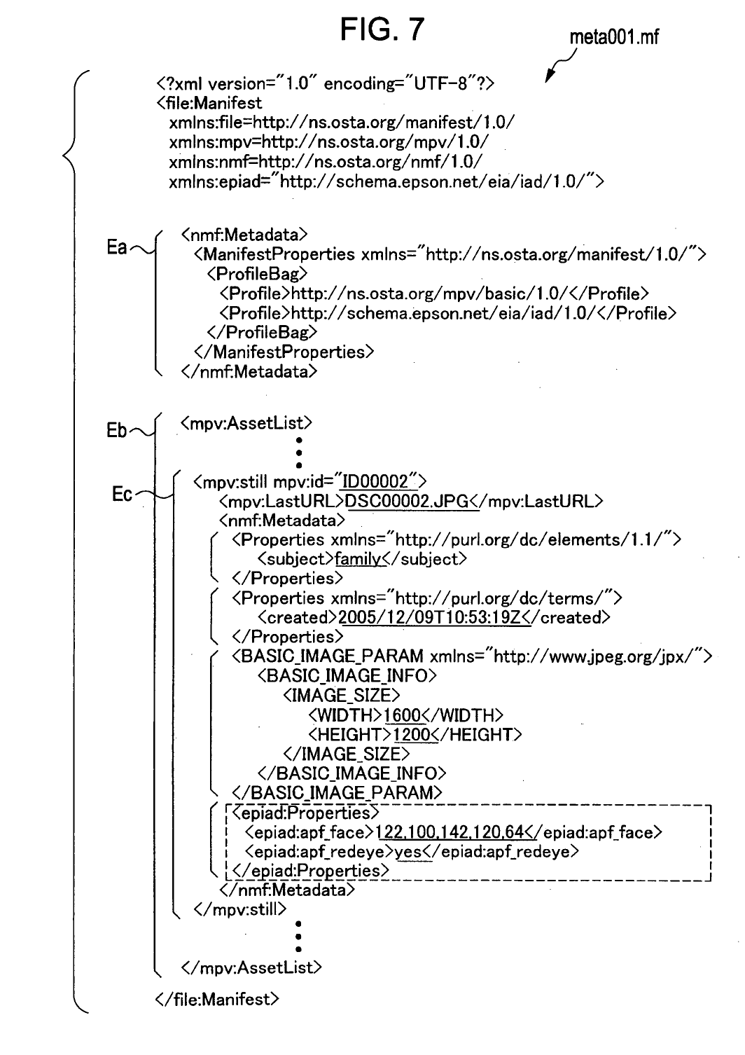

FIG. 7 shows an example of the content of metadata. In this embodiment, metadata is generated in known manifest file format.

As shown in FIG. 7, the metadata “mata001.mf” includes an element Ea of “nmf:Metadata” and an element Eb of “mpv:AssetList”. The element Ea describes the type of a manifest file. The element Eb describes information about one or more pieces of image data. Specifically, the element Eb includes an element Ec of “mpv:still” for each image data. Each of the “mpv:still” elements Ec describes information about a single piece of image data. An identifier assigned to the single piece of image data is described within a tag of <mpv:still>. FIG. 6 shows an identifier assigned to each image data. As shown in FIG. 6, a different identifier is assigned to each image data. The “mpv:still” element Ec shown in FIG. 7 corresponds to the image data “DSC00002.JPG” shown in FIG. 6. An identifier of “ID00002”, which is assigned to the image data “DSC000002.JPG”, is described within the tag <mpv:still>.

The element Ec includes an element of “mpv:LastURL” and an element of “nmf:Metadata”. The “mpv:LastURL” element describes the name of image data (e.g., DSC00002.JPG). The “nmf:Metadata” element includes two elements of “Properties”, an element of “BASIC_IMAGE PARAM”, and an element of “epiad:Properties”.

The content of the “epiad:Properties” element is generated on the basis of analysis data shown in FIG. 4. Specifically, the description of the “epiad:Properties” element is generated as storage data in step S206. As shown in FIG. 7, analysis data described in the “epiad:Properties” element is associated with the name of image data described in the “mpv:LastURL” element.

The “epiad:Properties” element includes an element of “epiad:apf_face” and an element of “epiad:apf_redeye”. The content of the “epiad:apf_face” element indicates the “face area” information and the “average luminance of face area” information shown in FIG. 4. Specifically, among five numerical values of (122, 100, 142, 120, 64) described between two tags of <epiad:apf_face>and </epiad:apf_face>, the first four numerical values (122, 100, 142, 120) correspond to the “face area” information shown in FIG. 4, and the last one numerical value (64) corresponds to the “average luminance of face area” information shown in FIG. 4. The content of the “epiad:apf_redeye” element corresponds to the “red eye” information shown in FIG. 4. Specifically, when the red-eye effect occurs, “yes” is described between two tags of <epiad:apf_redeye> and </epiad:apf_redeye>, whereas, when the red-eye effect does not occur, “no” is described therebetween.

The first “Properties” element included in the “nmf:Metadata” element describes a character string entered by a user (“family”). The second “Properties” element describes the date and time of generation of image data (“2005/12/09T10:53:19Z”). The “BASIC_IMAGE_PARAM” element included in the “nmf:Metadata” element describes the size of image data (1600*1200). The content of each of the two “Properties” elements and the “BASIC_IMAGE_PARAM” element is described on the basis of additional information corresponding to image data. Specifically, image data is typically stored in the exchangeable image file format (Exif). An Exif file has a structure based on an image data format standard for digital cameras (Exif). The Exif specifications are defined by the Japan Electronics and Information Technology Industries Association (JEITA). An Exif file has an image-data storage region for storing image data and an additional-information storage region for storing additional information for the image data. The additional information can include a character string entered by a user, the date and time of generation of image data captured by a digital camera during image capturing, the size of image data, and conditions of image capturing. In this embodiment, on this additional information, the contents of the two “Properties” elements and the “BASIC_IMAGE_PARAM” element are described.

A-3 Use of Analysis Data

A-3-1 First Usage

As described with reference to FIGS. 3 and 4, in this embodiment, when specific image data selected as a print target is second-type image data, in step S128 (FIG. 3), the specific image data is subjected to analysis processing, and specific analysis data is generated. The specific analysis data is then registered in the analysis table TB. Therefore, when the specific image data is selected as a print target again, in step S126, the specific analysis data can be read from the analysis table TB and used in correction processing in step S130.

As described above, in this embodiment, since second analysis data is stored in the analysis table TB in association with image data selected as a print target, when the image data is selected as a print target again afterwards, the second analysis data can be used as first analysis data. As a result, the time required for generation of print data can be reduced.

A-3-2 Second Usage

As described with reference to FIGS. 5 to 7, in this embodiment, image data and metadata are stored in a destination storage medium (CD-R). Therefore, the destination storage medium can be used as the above-described source storage medium. In this case, second analysis data included in metadata stored in the destination storage medium is treated as first analysis data, and corresponding image data is treated as first-type image data.

When a destination storage medium is used as a source storage medium, the same reading processing as in FIG. 2 is performed. However, in step S108, it is determined that metadata is present in the storage medium. Therefore, processing of step S110 is performed. As a result, a plurality of analysis data (first analysis data) that is included in metadata and that corresponds to a plurality of image data is registered in the analysis table TB.

In this case, the same printing processing as in FIG. 3 is performed. Here, it is assumed that, in step S122, image data that was a print target is selected as print-target image data again. At this time, in step S124, it is determined that the analysis table TB has analysis data corresponding to the print-target image data. Therefore, in step S126, the analysis data can be read from the analysis table TB and used in correction processing in step S130.

As described above, in this embodiment, since second analysis data is stored into a destination storage medium in association with corresponding image data, the destination storage medium can be used as a source storage medium. Therefore, if the image data is selected as a print data again, the second analysis data can be used as first analysis data. As a result, the time required for generation of print data can be reduced. A destination storage medium may be used as a source storage medium in the printer 200. Alternatively, a destination storage medium may be used as a source storage medium in a different printer or personal computer that can generate print data using analysis data.

### B Second Embodiment

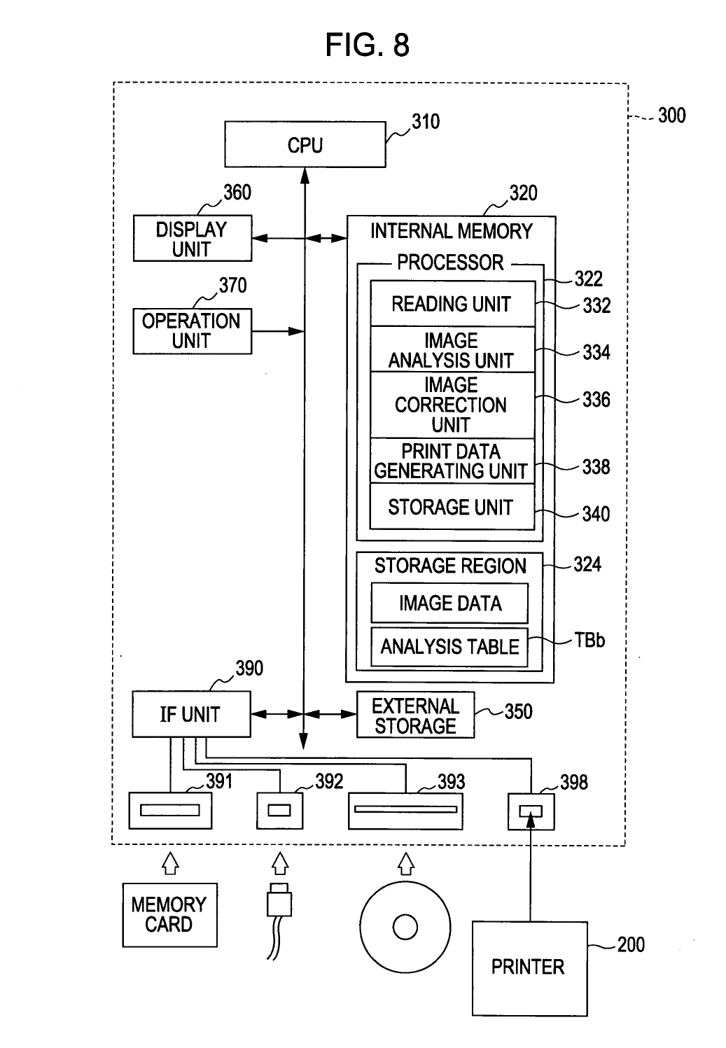

FIG. 8 is a block diagram of a print system according to a second embodiment. As shown in the drawing, a print system includes a personal computer 300 and the printer 200 according to the first embodiment.

The personal computer (hereinafter, sometimes referred to simply as “computer”) 300 includes a CPU 310, an internal memory 320 (e.g., ROM and RAM), an external storage 350 (e.g., hard disk), a display unit 360, an operation unit 370 (e.g., mouse and keyboard), and an interface (I/F) unit 390.

The I/F unit 390 includes a plurality of interfaces, as in the I/F unit 290 in the printer 200. For example, the I/F unit 390 includes a card slot 391, a USB terminal 392, and a CD drive 393. The I/F unit 390 also includes a print output terminal 398 for connecting to the printer 200 to supply print data to the printer 200.

The internal memory 320 contains a computer program that functions as a processor 322, as in the internal memory 220 shown in FIG. 1. The processor 322 includes a reading unit 332, an image analysis unit 334, an image correction unit 336, a print-data generating unit 338, and a storage unit 340, as in the processor 222 shown in FIG. 1. The internal memory 320 includes a storage region 324, as in the internal memory 220 shown in FIG. 1. The storage region 324 may be disposed within the external storage 350.

The processor 322 in the personal computer 300 can perform the same processing as in the processor 222 in the printer 200 according to the first embodiment. Specifically, the reading unit 332 reads image data from a source storage medium (e.g., flash memory). The image analysis unit 334 analyzes the image data and generates analysis data. The image correction unit 336 corrects the image data using the analysis data and generates corrected image data. The print-data generating unit 338 generates print data using the corrected image data. The storage unit 340 stores the storing-target image data and metadata including the corresponding analysis data into a destination storage medium (e.g., CD-R). The processor 322 in the personal computer 300 can supply print data to the printer 200 via the print output terminal 398. At this time, the processor 222 in the printer 200 can receive the print data and cause the print unit 280 to perform printing.

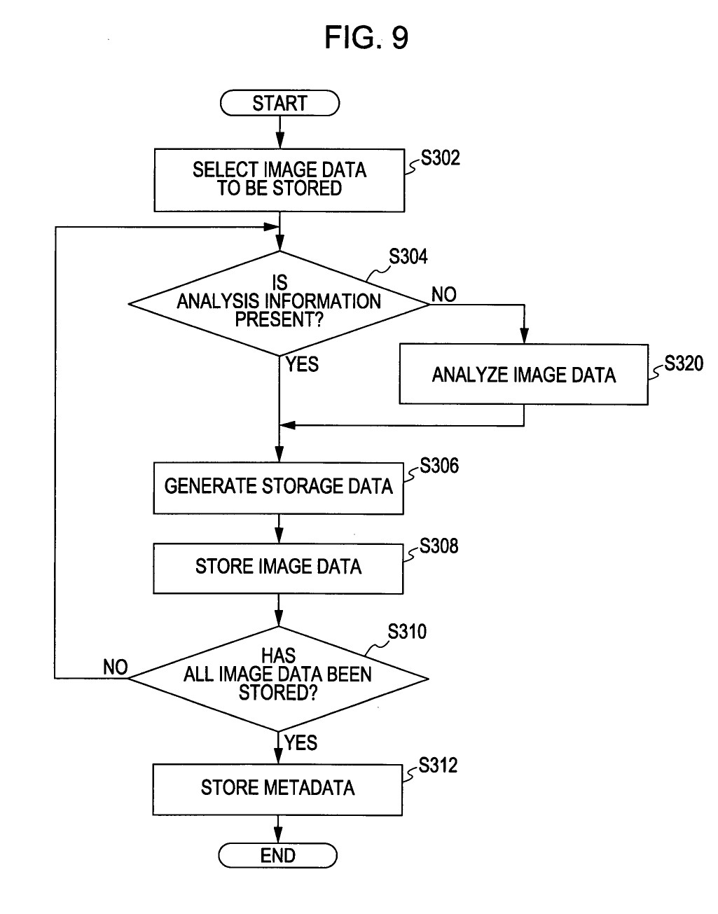

FIG. 9 is a flowchart that shows a procedure of storing processing performed in the personal computer 300. In the personal computer 300, before processing shown in FIG. 9, the same reading processing as in FIG. 2 is performed. Before the processing shown in FIG. 9, processing of generation of print data shown in FIG. 3 may be performed or may not be performed.

Steps S302 to S312 shown in FIG. 9 are substantially the same as steps S202 to S212 shown in FIG. 5, with the difference that step S320 has been added in FIG. 9. Specifically, if, in step S304, it is determined that analysis data corresponding to storing-target image data is not registered in an analysis table TBb, the processing proceeds to step S320. In step S320, the image analysis unit 334 analyzes the storing-target image data and registers the analysis data into the analysis table TBb, as in step S128 (FIG. 3).

The performance of processing of step S320 generates a plurality of analysis data corresponding to all a plurality of storing-target image data selected in step S302. Therefore, metadata generated in step S312 includes the plurality of analysis data corresponding to the plurality of storing-target image data.

That is, in the first embodiment (FIG. 5), if image data whose analysis data has not been generated (second-type image data) is selected as a storing target, the image data is not subjected to analysis processing in the printer 200, and only the image data is stored in a destination storage medium. In contrast, in the second embodiment, if image data whose analysis data has not been generated (second-type image data) is selected as a storing target, the image data is subjected to analysis processing in the personal computer 300, and both the image data and metadata including the analysis data are stored in a destination storage medium. The reason why all print-target image data is subjected to analysis processing in the second embodiment is that the throughput of the personal computer 300 (specifically, the CPU 310) is higher than that of the printer 200 (specifically, the CPU 210).

When the destination storage medium is used as a source storage medium in the printer 200 or the personal computer 300, since analysis data for each image data exists, the time required for analysis can be omitted.

The invention is not limited to the embodiments described above and can be made in various forms without departing from the sprit and scope thereof. For example, the following modification can be made.

(1) In the above embodiments, in step S104 in FIG. 2, all image data stored in a source storage medium is read and stored into a storage region in the printer 200 or the personal computer 300. This process can be omitted. In this case, when print-target image data is selected in step S122 in FIG. 3, or when storing-target image data is selected in step S202 in FIG. 5 (step S302 in FIG. 9), only the selected image data is read from the source storage medium.

(2) In the above embodiments, a source storage medium and a destination storage medium are different. However, they may be the same. That is, metadata may be stored in a source storage medium. In this case, since image data is present in a destination storage medium, storing processing of image data is omitted. Specifically, processing of step S208 in FIG. 5 (step S308 in FIG. 9) is omitted.

(3) In the above embodiments, when the analysis table TB has already-existing first analysis data and newly generated second analysis data, metadata including both the first analysis data and the second analysis data is stored into a destination storage medium. However, in place of this, metadata including only second analysis data may be stored into a destination storage medium. In this case, the analysis table TB further registers a flag that indicates whether analysis data is second analysis data newly generated by the image analysis unit, and metadata is generated by the use of the flag.

Generally, at least second analysis data is stored in a destination storage medium in association with corresponding image data.

(4) In the above embodiments, a single piece of metadata including a plurality of analysis data corresponding to a plurality of image data is generated. However, in place of this, a single piece of metadata may be generated for each image data such that the single piece of metadata includes only a single piece of analysis data corresponding to a single piece of image data.

In the above embodiments, analysis data is contained in an analysis file (i.e., metadata) that is different from an image file that contains image data. However, in place of this, analysis data may be contained in an image file that contains image data. Specifically, as described above, image data is typically stored in Exif format. An Exif file has an image-data storage region for storing image data and an additional-information storage region. Analysis data is stored in a makernote area, which is assigned to maker information, within the additional-information storage region. This enables the analysis data to be easily associated with corresponding image data.

(5) In the above embodiments, part of a structure realized by hardware can be replaced with software. Conversely, part of a structure realized by software can be replaced with hardware.

The disclosure of Japanese Patent Application No. 2006-063474 filed Mar. 9, 2006 including specification, drawings and claims is incorporated herein by reference in its entirety.

What is claimed is:

1. An image processing apparatus for printing, the image processing apparatus comprising:
an analysis unit that, when first analysis data corresponding to target image data has been generated, does not perform analysis processing on the target image data and, when first analysis data corresponding to the target image data has not been generated, performs analysis processing on the target image data and generates second analysis data;
a correction unit that corrects the target image data using the first or second analysis data corresponding to the target image data and generates corrected image data;
a print-data generating unit that generates print data using the corrected image data; and
a storage unit that stores the second analysis data in association with the corresponding target image data.

2. The image processing apparatus according to claim 1, wherein the storage unit stores the second analysis data in association with the corresponding target image data into a destination storage medium outside the image processing apparatus.

3. The image processing apparatus according to claim 2, wherein the target image data is read from a source storage medium outside the image processing apparatus,
wherein the destination storage medium is different from the source storage medium, and
wherein the storage unit stores the corresponding target image data together with the second analysis data into the destination storage medium.

4. The image processing apparatus according to claim 3, wherein the storage unit stores the second analysis data in a state of being contained in an analysis file different from an image file that contains the corresponding target image data.

5. The image processing apparatus according to claim 4, wherein the second analysis data is constituted by a plurality of pieces of second analysis data and the target image data is constituted by a plurality of pieces of target image data, and
wherein the analysis file contains the plurality of pieces of second analysis data corresponding to the plurality of pieces of target image data.

6. The image processing apparatus according to claim 3, wherein the storage unit stores the second analysis data in a state of being contained in an image file that contains the corresponding target image data.

7. The image processing apparatus according to claim 2, wherein the target image data is read from a source storage medium outside the image processing apparatus, and
wherein the destination storage medium is the same as the source storage medium.

8. A method for processing image data, the method being executed by an image processing apparatus for printing, the method comprising:
(a) when first analysis data corresponding to target image data has been generated, not performing analysis processing on the target image data and, when first analysis data corresponding to the target image data has not been generated, performing analysis processing on the target image data and generating second analysis data;
(b) correcting the target image data using the first or second analysis data corresponding to the target image data and generating corrected image data;
(C) generating print data using the corrected image data; and
(d) storing the second analysis data in association with the corresponding target image data.

9. A program product for causing an image processing apparatus for printing to execute processing for image data, the computer program causing the image processing apparatus to perform:
a function of, when first analysis data corresponding to target image data has been generated, not performing analysis processing on the target image data and, when first analysis data corresponding to the target image data has not been generated, performing analysis processing on the target image data and generating second analysis data;
a function of correcting the target image data using the first or second analysis data corresponding to the target image data and generating corrected image data;
a function of generating print data using the corrected image data; and
a function of storing the second analysis data in association with the corresponding target image data.

10. A computer-readable storage medium that stores a program product according to claim 9.
